(19) United States
(12) Patent Application Publication
(10) Pub. No.: US 2008/0292757 A1
(43) Pub. Date: Nov. 27, 2008

(54) Method of Production a Sweet, a Forming Core for Production a Sweet Shell and a Sweet Produced by the Same Method

(75) Inventors: Alexander Vladimirovich Peskin, Moscow (RU); Olga Evgenievna Savelieva, Moscow (RU); Julia Vladimirovna Prusakova, Moscow (RU); Oleg Alexandrovich Kuzmin, Moscow (RU); Alexey Ivanovich Sukharev, Voronezh (RU)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: OBSCHESTVO S OGRANICHENNOY OTVETSTVENNOSTJU "MARS", Moskovskaya oblast (RU)

(21) Appl. No.: 12/096,697

(22) PCT Filed: Dec. 4, 2006
(86) PCT No.: PCT/RU2006/000650

§ 371 Date: Jul. 29, 2008

(30) Foreign Application Priority Data
Dec. 9, 2005 (EA) 200600142

(51) Int. Cl. A23G 3/54

(52) U.S. Cl. 426/94; 426/103; 426/283; 426/306

(57) ABSTRACT

The method of production of sweet comprises shell (1) molding of chocolate or a chocolate or a confectionary glaze and of other masses with the use of a forming core (8), and filling the obtained shell with fillings of different kinds, wherein the forming core has cuts (9) in the lower end forming barriers (2) in the inner chamber of the shell, where each chamber formed by the barriers is provided with a filling. The sweet contains a shell (1) in the form of a container divided by barriers (2) into two or more chambers (3) and fillings (4) of different kinds, disposed in the said chambers (3), which allows the consumer to define visually the kind of the filling in each shell chamber (3) and thus provides free ingress to the particular kind of filling (4) at the consumer's choice.

The invention relates to the food industry, in particular the confectionary manufacture, more particularly sweets and production thereof.

There is a known method of production of confectionary article disclosed in the U.S. Pat. No. 6,103,279 which suggests production of two wafer half-shells, filling of them with a filling mass, providing the filling with a caramel core, coupling of the half-shells and coating them with chocolate. Confectionary article produced according to this method has peculiar organoleptic features due to the combination of different textures but it does not allow use of fillings of different kinds and as a result combinations of various flavor shades especially at the consumer's own choice.

There is a sweet known from the U.S. Pat. No. 5,985,341 produced in the form of a spherical chocolate shell divided by a chocolate barrier into two chambers each containing a different kind of the filling. The sweet is manufactured by molding of two chocolate hemispheres, providing them with different kinds of fillings, covering of the filling of one hemisphere with a chocolate coating and coupling of the hemispheres. This sweet doesn't allow ingress to a definite kind of the filling at the consumer's choice.

There is a known method of production of chocolate sweets of an allsorts kind according to the RU Patent No. 2241341 which describes chocolate shell molding by immersing the forming cores cooled to the temperature of (−12)-(−14)° C. into a tank with tempered chocolate followed by vibration and separation the resulted chocolate forms by compressed air, cooling of the resulted shell and disposing of the filling inside them in layers. But the sweet produced by the known method although affords the possibility of sensing different tastes on its layer-by-layer eating still does not allow to choose the filling of a particular kind, since different kinds of fillings lay in layers in the chocolate container.

The object of the present invention is a method of producing a sweet which provides an article that allows the consumer's ingress to the desired segment containing a certain kind of the filling or to the combination of fillings if selected and improvement of organoleptic features of the sweet taking into consideration possible combination of different textures. Besides, the objects of the present invention are to develop a forming core to be used in the method of production a sweet as well as the construction of a sweet produced by this method.

This object is achieved in one embodiment of the present invention by the method of production a sweet which method includes shell molding by immersing forming cores of the molds cooled to the temperature less than the crystallization temperature of a chocolate mass or a chocolate or a confectionary glaze mass into a tank with tempered chocolate mass or a chocolate or a confectionary glaze mass, holding of forming cores of the mold in the tank; extraction of forming cores from the tank followed by holding, separation of the obtained shells by compressed air and providing them with different kinds of fillings, each forming core having cuts in the lower end forming barriers in the inner chamber of the shell.

Another embodiment of the invention is characterized in that the method of sweets production includes shell molding by pouring over a forming core tempered chocolate mass or a chocolate or a confectionary glaze mass, with the forming core being cooled to the temperature less than the crystallization temperature of chocolate mass or a chocolate or confectionary glaze mass, holding of the forming core, separation of the obtained shells by compressed air and providing them with different kinds of fillings, wherein cuts are made on the side of operating end of the forming core which cuts form barriers in the inner chamber of the shell.

The third embodiment of the invention is characterized in that the method of production a sweet includes shell molding by dosated filling of the mold with tempered chocolate mass or a chocolate or a confectionary glaze mass or a toffee mass or a butter-scotch mass, immersing the forming core cooled to the temperature less than the crystallization temperature of the filled mass, into the mold, holding and extracting of the forming core from the mold, extraction of the obtained shell from the mold and providing it with different kinds of the filling, wherein each forming core has cuts in the lower end forming barriers in the inner chamber of the shell.

The forth embodiment of the invention is characterized in that the method of production a sweet includes shell molding by dosated filling of the mold with tempered chocolate mass or a chocolate or a confectionary glaze mass, immersing the forming core made of a frozen or a hardened filling and cooled to the temperature less than the crystallization temperature of a chocolate or a glaze mass and the melting temperature of the filling which constitutes the forming core into the mold, holding and extracting of the forming core from the mold considering that forming core has cuts in the lower end forming barriers in the inner chamber of the shell, and after the extraction of the forming core from the mold a part of forming core is cut off to equal the height of the chocolate shell.

The fifth embodiment of the invention is characterized in that the method of production a sweet includes shell molding by dosated filling of the mold with tempered chocolate mass or a chocolate or a confectionary glaze mass or a toffee mass or a butter-scotch mass, immersing into the mold the forming core the lower part of which is made of a frozen or a hardened filling, and which is cooled to the temperature less than the crystallization temperature of a chocolate or a confectionary glaze mass or a toffee mass or a butter-scotch mass and less than the melting temperature of the filling which constitutes the forming core, holding and extracting of the forming core from the mold considering that each forming core has cuts in the lower end forming barriers in the inner chamber of the shell, and after the extraction of the forming core from the mold the lower part of the forming core is disconnected.

The sixth embodiment of the invention is characterized in that the method of a sweet production includes molding of a wafer shell or a shell made of a flour confectionary mass by dosated filling of the mold with the dough, immersing of the forming core into the mold, holding it at the predetermined baking temperature of the article and extraction of the forming core from the mold, extraction of the obtained shell from the mold, covering the shell with chocolate or a chocolate or confectionary glaze and providing it with different kinds of fillings considering that each forming core has cuts in the lower end forming barriers in the inner chamber of the shell.

In accordance with another aspect of the invention a forming core is developed which is used for production of sweet shells, characterized in that its operative end has cuts for forming barriers in the inner chamber of the shell.

The forming core may be entirely made of frozen or hardened fillings of different kinds or it may be composite with lower part of operative end being made of frozen or hardened fillings of different kinds.

One more aspect of the invention is the development of a sweet manufactured by any of the abovementioned methods and characterized in that it comprises a shell in the form of a container divided by barriers into two or more chambers and fillings of different kinds contained in the said chambers. At that different chambers may contain one or several kinds of the filling.

The shell and the barriers may be made of chocolate, or a chocolate or a confectionary glaze, or of wafer covered with chocolate, or a chocolate or a confectionary glaze, as well as of a butter-scotch mass, or a toffee mass, or a flour confectionary mass.

The production of the sweet shell as a container divided by barriers into several chambers containing fillings of different kinds allows to define visually the type of the filling in each shell chamber and allows easy ingress to a definite kind of the filling at the consumer's choice. Furthermore with such making of a sweet there is a possibility of different combinations of fillings that are simultaneously bitten off. And at that the barriers provides the sweet with peculiar organoleptic features since when a part of a sweet is bitten off there is a crisp destruction of the barriers which causes pleasant sensation at the consumer. This effect is increased when the thickness of the barriers is less than that of the shell. This effect is perceptible at a higher degree when the shell or/and the barriers are made of wafer. In the latter case the chocolate coating or a chocolate or a confectionary glaze coating above supplying the sweet with corresponding flavor, functions as a isolating layer for the filling which prevents the soaking of the wafer by the filling, mixing of the flavors of the fillings and the loss of the wafer crisp features.

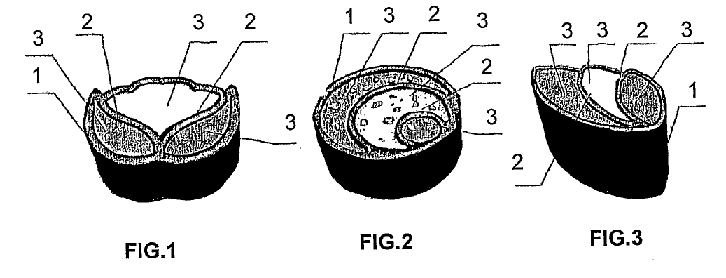

FIG. 1 is a perspective view of one embodiment of the form of the sweet;

FIG. 2 is a perspective view of another embodiment of the form of the sweet;

FIG. 3 is a perspective view of the third embodiment of the form of the sweet;

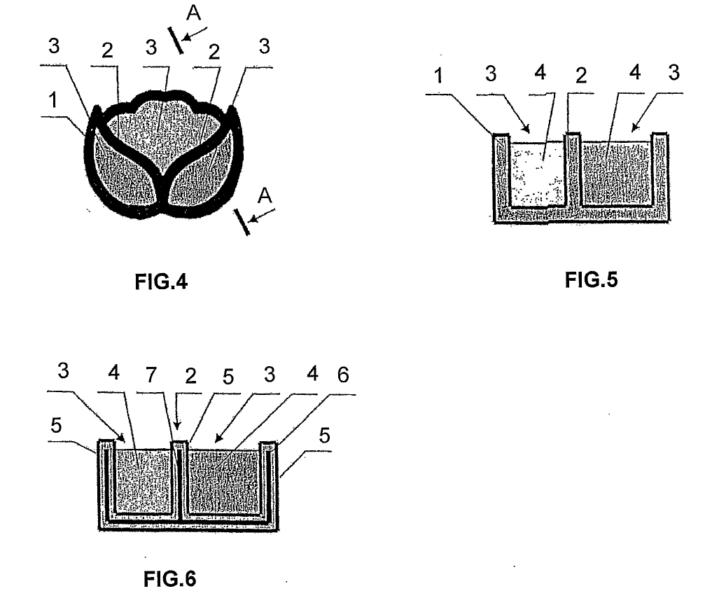

FIG. 4 is a plan view of the sweet;

FIG. 5 is a section view along the line A-A on FIG. 4 of one of the embodiments of the sweet (conditionally turned);

FIG. 6 is a section view along the line A-A on FIG. 4 of another embodiment of the sweet (conditionally turned);

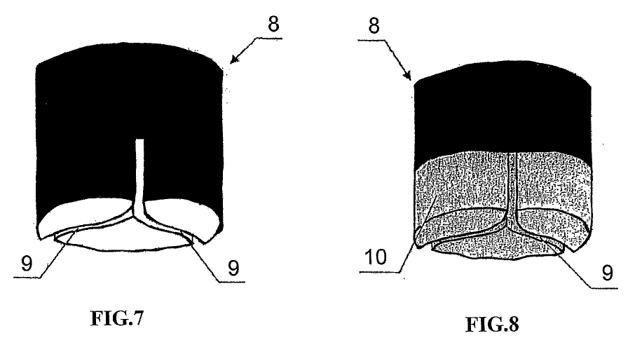

FIG. 7 is an isometric projection of a segment of one embodiment of a forming core shown from its operative end;

FIG. 8 is an isometric projection of a segment of another embodiment of a forming core shown from its operative end.

The sweet comprises a shell 1, made as a container, barriers 2, dividing the shell 1 into several chambers 3, filled with the filling 4 of one or different kinds. The shell 1 may have the thickness equal to the thickness of the barriers 2 or it may be less or more thick. The shell 1 may be made of chocolate, a chocolate or a confectionary glaze (FIG. 5) or it may be made in the form of a wafer chamber covered with chocolate or a chocolate or a confectionary glaze 5 or in the form of a chamber made of a toffee mass or a butter-scotch mass or a flour confectionary mass 6 (FIG. 6). The barriers 2 may also be made of chocolate or a chocolate or a confectionary glaze (FIG. 5) as well as in the form of walls 7 made of wafer or a toffee mass or a butter-scotch mass or a flour confectionary mass (FIG. 6) and they are covered with chocolate or a chocolate or a confectionary glaze 5.

In the first embodiment of the invention a sweet is produced according to the following method. The shell is formed by immersing of the forming cores of the molds which are cooled to the temperature less than the crystallization temperature of a chocolate mass or a chocolate or a confectionary glaze mass, into a tank with tempered chocolate mass or a chocolate or a confectionary glaze mass, holding of the forming core of the mold in the tank and extraction of the forming core from the tank followed by their holding and vibration, with further separation of the shell by compressed air and providing it with fillings of different kinds. At this there are cuts 9 in the operative end of the forming core 8 (FIG. 7) which form the barriers in the inner chamber of the shell. The height of the shell is adjusted by the depth of immersing of the forming core into the mass.

Another embodiment of the invention differs from the one described above in the process of shell production: the shell is formed by dosated filling of the mold with a tempered chocolate mass, or a chocolate or a confectionary glaze mass, or a toffee mass, or a butter-scotch mass, immersing into a mold of the forming core cooled to the temperature less than the crystallization temperature of the mass in the form, holding and extraction of the forming core from the form, extraction of the obtained shell from the mold and providing it with different kinds of fillings. At this the same forming core 8 with cuts 9 in its operative end is used. According to the third embodiment of the invention the sweet shell is formed as described in the previous embodiment but at this the forming core 8 with cuts 9 is used which is made of frozen or hardened fillings of different kinds. At that after the extraction of such forming core from the mold the shell is already filled with the filling and to obtain the sweet a part of the forming core is cut off to equal the height of the chocolate shell.

The forth embodiment of the invention differs from the third embodiment in the use of a composite forming core 8 (FIG. 8) the lower part 10 of which in the operative end is made of frozen or hardened fillings of different kinds. In this case to form a sweet the lower part 10 of the forming core is removed after the shell molding.

A feature of the fifth embodiment of the invention is a shell molding by pouring over the forming core 8 having cuts 9 with a tempered chocolate mass or with a chocolate or a confectionary glaze mass. At this the forming core 8 is cooled to the temperature less then the crystallization temperature of a chocolate mass or a chocolate or a confectionary glaze mass. The forming core is held till the shell is hardened and the resulted shells are separated for instance by compressed air and provided with fillings of different kinds.

The sixth embodiment of the invention is characterized in that the wafer shell or a flour confectionary mass shell is formed by dosated filling of the mold with dough, the forming core is immersed into the mold and is held at the predetermined baking temperature of the article and is further extracted from the mold. Then the resulted shell is extracted from the mold and covered with chocolate or a chocolate or a confectionary glaze and is provided with fillings of different kinds. At this the forming core 8 as in other embodiments of the invention contains cuts 9. The coating of the shell with chocolate or a chocolate or a confectionary glaze is carried out by either immersing of the shell into a melted mass or by spraying or pouring of the melted mass onto the shell.

During shell molding of the sweet with the use of a mold (all embodiments of the invention except the first one) the depth of the cuts 9 in the forming core 8 substantially equal the height of the mold. And in all embodiments of the invention different cavities may contain one or several kinds of the fillings.

1. A method of production of a sweet comprising shell molding by immersing the forming cores of the molds which are cooled to the temperature less than the crystallization temperature of a chocolate mass or a chocolate or a confectionary glaze mass, into a tank with tempered chocolate mass or a chocolate or a confectionary glaze mass, holding the forming cores of the molds in the tank and extraction of the forming cores of the molds from the tank followed by their holding, with further separation of the resulted shells by compressed air and providing it with fillings of different kinds, characterized in that the cuts are made on each forming cores at its lower end which form barriers in the inner chamber of the shell.

2. The method according to claim 1, characterized in that the height of the shell is adjusted by the depth of immersing of the forming core into the mass.

3. The method of production of a sweet, comprising shell molding by pouring over the forming core with tempered chocolate mass or a chocolate or a confectionary glaze mass, with the forming core being cooled to the temperature less than the crystallization temperature of chocolate or a chocolate or a glaze mass, holding of the forming core, extraction of the obtained shells by compressed air and providing them with different kinds of fillings, wherein the cuts are made on each forming cores at its operative end which form barriers in the inner chamber of the shell.

4. The method of production of a sweet, comprising shell molding by dosated pouring into the mold the tempered chocolate mass or a chocolate or a glaze mass or a toffee mass or a butterscotch mass, immersing into the mold the forming core cooled to the temperature less than the crystallization temperature of the mass poured into the mold, holding and extraction of the forming core from the mold, extraction of the obtained shell from the mold, and providing it with fillings of different kinds, characterized in that the cuts are made on each forming cores at its lower end which form barriers in the inner chamber of the shell.

5. The method of production of a sweet, comprising shell molding by dosated pouring into the mold tempered chocolate mass or a chocolate or a glaze mass, immersing into the mold of the forming core made of a frozen or a hardened filling and cooled to the temperature less than the crystallization temperature of a chocolate mass or a chocolate or a glaze mass and less than the melting temperature of the filling which constitutes the forming core, holding and extraction from the mold of the forming core, wherein the lower end of the forming core has cuts forming barriers in the inner chamber of the shell with a part of the forming core being cut off after the extraction to equal the height of the chocolate shell.

6. The method of production of a sweet, comprising shell molding by dosated pouring into the mold the tempered chocolate mass or a chocolate or a glaze mass, or a toffee mass, or a butterscotch mass, immersing into the mold of the forming core the lower part of which is made of a frozen or a hardened filling and which is cooled to the temperature less than the crystallization temperature of a chocolate mass or a chocolate or a glaze mass, or a toffee mass or a butterscotch mass and the melting temperature of the filling which constitutes the forming core, holding and extraction the forming core from the mold wherein the lower end of the forming core has cuts forming barriers in the inner shell chamber with the lower part of the forming core being removed after the extraction.

7. The method according to claim 6, characterized in that the height of the lower part of the forming core substantially equals the height of the form.

8. The method according to any of claim 5, characterized in that the forming core is cooled by blowing with cold air.

9. The method of production of a sweet, comprising molding of a wafer shell or a flour confectionary mass shell by dosated filling of the mold with dough, immersing of the forming core into the mold, holding at the predetermined baking temperature of the article and extraction of the forming core from the mold followed by extraction of the obtained shell from the mold, coating of the shell with chocolate or a chocolate or a confectionary glaze and providing it with fillings of different kinds, characterized in that the cuts are made on forming core at its lower end which form barriers in the inner chamber of the shell.

10. The method according to claim 4, characterized in that the depth of the cuts in the forming core substantially equals the height of the form.

11. The method according to claim 1, characterized in that at least two chambers contain different kinds of fillings.

12. The method according to claim 1, characterized in that all chambers contain fillings of different kinds.

13. The method according to claim 9, characterized in that the coating of the shell with chocolate or a chocolate or a confectionary glaze is carried out by immersing it into a melted chocolate mass or a chocolate or a confectionary glaze mass.

14. The method according to claim 9, characterized in that the coating of the shell with chocolate or a chocolate or a confectionary glaze is carried out by spraying a melted chocolate mass or a chocolate or a confectionary glaze mass onto the shell.

15. A forming core for production of the shells of chocolate sweets, characterized in that the forming core has cuts in its operative end forming barriers in the inner chamber of the shell.

16. The forming core according to claim 15, characterized in that it is made of frozen or hardened fillings of different kinds.

17. The forming core according to claim 15, characterized in that it is composite with its part of the lower end being made of frozen or hardened fillings of different kinds.

18. A sweet, produced according to claim 1, characterized in that it comprise a shell in the form of a container divided by barriers into two or more chambers, and fillings of different kinds disposed in said chambers.

19. The sweet, according to claim 18, characterized in that at least two chamber comprise fillings of different kinds.

20. The sweet, according to claim 18, characterized in that all chambers contain fillings of different kinds.

21. The chocolate sweet, according to claim 18, characterized in that the shell and the barriers are made of chocolate or of a chocolate or a confectionary glaze or of a butter-scotch mass or of a toffee mass.

22. The chocolate sweet, according to claim 18, characterized in that the shell and the barriers are made of wafer or of a flour confectionary mass, covered with chocolate or a chocolate or a confectionary glaze.
